(19) United States
(12) Patent Application Publication
(10) Pub. No.: US 2009/0107644 A1
(43) Pub. Date: Apr. 30, 2009

(54) Dry Strength System for the Production of Paper and Board

(76) Inventors: John Stuart Cowman, Bradford (GB); Adrian Fox, West Yorkshire (GB); Andrew Mottram, West Yorkshire (GB); Paul Dekock, Bradford (GB)

Correspondence Address: CLARIANT CORPORATION;INTELLECTUAL PROPERTY DEPARTMENT, 4000 MONROE ROAD, CHARLOTTE, NC, 28205, US

(21) Appl. No.: 12/086,943

(22) PCT Filed: Dec. 7, 2006
(86) PCT No.: PCT/EP2006/069412

§ 371 Date: Jun. 20, 2008

(30) Foreign Application Priority Data
Dec. 22, 2005 (EP) 05112788.4

(51) Int. Cl. D21H 21/18; C08G 69/40

(52) U.S. Cl. 162/164.6; 528/288

(57) ABSTRACT

The instant invention relates to certain cross-linked polyamides and their use in the paper and board industry for improving dry strength. The polyamide from the reaction of a di- or tri-primary amine with a di- or tri- or tetra carboxylic acid is further reacted with a di- or tri-functional cross-linking compound to give a cationic or anionic product with no reactive groups.

The instant invention relates to cross-linked polymers, based on polyamide chemistry, and their use in the paper and board industry for improving dry strength.

A large quantity of waste paper and board is recycled, providing a source of cellulosic fibre raw material for paper. Wastepaper, which has previously been treated with a wet-strength resin is difficult to break down in the pulping process and is therefore not a viable raw material for paper manufacture. On the other hand, the quality of fibre in wastepaper is deteriorating, due to increased recycling, and the dry strength of a paper sheet inevitably suffers as a consequence. There is now a desire to raise the standards, associated with dry strength, closer to the values achieved with virgin fibre. The majority of paper manufacture is now carried out under neutral pH conditions, quantified by values between 6.0 and 8.0 and new technologies must function efficiently under these conditions.

### PRIOR ART

Dry strength additives have been available in the paper industry for many years. Natural polymers such as starch, either in its native or chemically modified form, have been employed relatively successfully due to their over abundance and low cost. There has been a temptation to add excessively high amounts of starch because, although low in cost, the strength performance of starch, per dry kilogram per tonne of cellulosic fibre, is between 5 and 10 times less than a synthetic dry strength polymer. Starch, even in its cationised form, has a low affinity for paper fibres and large quantities of solubilised material remain in the water circuits of the paper machine, where they act as nutrients for bacteria and interfere with the affinity of other papermaking additives.

One of the first synthetic technologies for improving the dry strength of paper was based on copolymers of acrylamide. Anionic versions of this chemistry are much in use today, normally combined with a cationic promoter, to aid adsorption on the paper fibres. The requirement for two chemicals, one of which may not contribute to strength, is often cost prohibitive.

Polyacrylamide technology was enhanced by adding aldehyde reactivity. Glyoxylated polyacrylamides were introduced to improve strength through the use of latent reactive aldehyde groups, which undergo inter-polymer cross-linking during the drying of the paper sheet at 80-100° C. The reactivity of glyoxal is difficult to control and polymers continue to increase in viscosity during storage, reducing shelf life. The aldehyde reaction is pH specific and performance suffers above pH 6.5. If the reactivity of these polymers is too efficient, the wet strength of the treated paper is too strong and interferes with the re-pulping process.

Polyamideamine polymers, further reacted with epichlorohydrin, have been used successfully in the paper industry for many years as wet strength resins. These additives are very reactive, especially at pH values greater than 6.0 and temperatures higher than 80° C. Cross-linking between polymer chains takes place within the treated paper sheet, decreasing the solubility of the resin and preventing water from disrupting the inter-fibre hydrogen bonding. It is clear that this chemistry also provides a high level of dry strength but this fact is often irrelevant if the paper, in the form of pre- or post consumer waste, cannot be re-pulped.

### SUMMARY OF THE INVENTION

It has now been found that certain cross-linked polyamides have excellent properties as a dry strength system for the production of paper and board.

The reaction of a di- or tri-primary amine with a di- or tricarboxylic acid yields a polyamide with a 3-dimensional structure, which is then further reacted, to increase its molecular weight, with a di- of tri-functional cross-linking compound. The increased bulk of the 3-dimensional polymer structure is more efficient for bridging the gap between cellulosic fibres, allowing a greater number of hydrogen bonds to contribute to inter-fibre bonding. The reaction of the polyamide polymer with the cross-linker is carefully controlled to eliminate any free reactive groups in the final product, because it is known that such reactivity contributes to wet strength, which in many cases is undesirable. The cross-linked polyamide polymer solutions, which are dominantly cationic or anionic, depending on their designed construction, may be applied to an aqueous cellulosic fibre slurry, sprayed on to a fibrous wet web or added to a partially dried sheet at a size press or film press. The cationic polymer variants are self retaining and their adsorption on cellulosic fibres is independent of pH. This new technology also provides synergistic improvements in dry strength, when combinations of cationic and anionic polymer variants are applied.

The present invention seeks to employ all the advantages of polyamide chemistry, without the undesirable reactivity, associated with wet strength resins. The 3-dimensional polymers have a long shelf life, an active content of 20%, a pH of 6-7 and are AOX free.

Therefore an object of the present invention is a cross-linked polymer formed by reaction between a polyamide polymer backbone (a), with or without side chains, which is the reaction product of a di- or tri-primary amine or mixtures thereof, and a di- or tri- or tetra-carboxylic acid or mixtures thereof, and a trifunctional crosslinking agent (b), based on trichloro-, triepoxy- or trivinyl-chemistry.

The dominant charge of the polymer created by the reaction of (b) with (a) is cationic or anionic.

The di- or tri-primary amine may possess secondary or tertiary amine groups within its structure.

The di-primary amine is selected from diethylenetriamine, triethylenetetramine, tetraethylenepentamine, ethylene diamine, 1,3-diaminopropane, 1,4-diaminobutane, 1,6-hexanediamine, iminobispropylamine, N-methyl-bis-(aminopropyl)amine, bis-hexamethylenetriamine, 4,4′-methylenedianiline, 1,4-phenylenediamine or 4-aminophenyl sulphone. Preferred is 4,4′-methylenedianiline or diethylenetriamine.

The tri-primary amine preferably is tris(2-aminoethyl)amine. Also preferred are

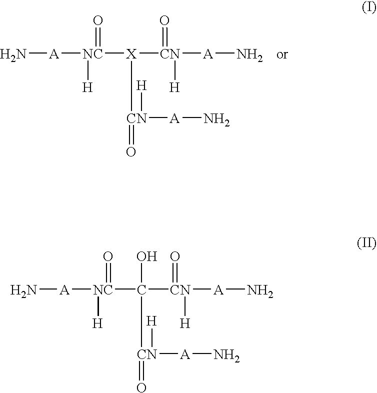

where A is —(CH₂)₂₋₆— and X is benzene.

The molar ratio of di- to tri-primary amine in the polyamide backbone polymer is 1:0 to 0.5:0.5.

The di-carboxylic acid is selected from oxalic, malonic, succinic, glutaric, adipic, pimelic, suberic, azelaic, sebacic, maleic, fumaric, itaconic, phthalic, isophthalic, terephthalic and 1,-4 cyclohexanedicarboxylic acid. Preferred are adipic or terephthalic acid.

The tri-carboxylic acid is selected from citric, 1,2,3-benzenetricarboxylic, 1,2,4-benzenetricarboxylic, 1,3,5-benzenetricarboxylic acid, nitrilotriacetic or N-(2-hydroxyethyl)-ethylenediamine triacetic acid. Preferred are 1,2,4-benzenetricarboxylic or nitrilotriacetic acid.

The di- and tri-carboxylic acids may also be used in the form of their corresponding ester, halide or anhydride derivatives.

The molar ratio of di- to tri-carboxylic acid in the polyamide backbone polymer is 1:0 to 0.5:0.5.

The molar ratio of carboxylic acid to primary amine, for the preparation of the polyamide polymer, is from 0.9:1.0 to 1.0:0.9.

The polyamide polymer, with internal secondary amine groups, may be further reacted with benzyl chloride, propylene oxide, ethylene oxide, glycidol or a C₄-C₁₈-alkenyl succinic anhydride, forming a dominantly cationic polymer backbone with side chains.

The polyamide polymer, with internal secondary amine groups, may be further reacted with acrylic acid, chloroacetic acid, glyoxylic acid or 3-chloro-2-hydroxy-1-propanesulphonic acid sodium salt, in the presence of sodium or potassium hydroxide, forming a dominantly anionic polymer backbone at a pH value >6.0.

The polyamide polymer, without internal secondary amine groups, may be further reacted with glyoxylic acid in the presence of sodium or potassium hydroxide, forming a nonionic polymer backbone with anionic side chains.

The molar ratio of polymer backbone to side chain component is 1:0 to 1:0.7.

The tri-functional cross-linking compound (b) may be selected from tris-(3-chloro-2-hydroxypropyl)-2-hydroxy-propanol, tris-(3-chloro-2-hydroxypropyl)-sorbitol, tris-(3-chloro-2-hydroxypropyl)-1,2,3-propoxy-glycerol, glycerol propoxylate triglycidyl ether, N,N-diglycidyl-4-glycidyloxyaniline, N,N-(3-chloro-2-hydroxypropyl)-4-(3-chloro-2-hydroxypropyl)-oxyaniline, glycerol propoxylate triacrylate, trimethylolpropane triglycidyl ether, trimethylolpropane trimethacrylate, triphenylolmethane triglycidyl ether and tris(2,3-epoxypropyl isocyanurate. Preferred are N,N-diglycidyl-4-glycidyloxyaniline or glycerol propoxylate triglycidyl ether.

Also preferred for (b) is

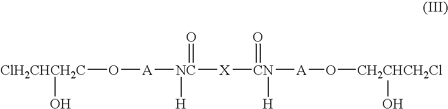

where A is —(CH₂)₂₋₆— and X is benzene or —(CH₂)₂₋₆—.

The cross-linked polyamide polymer is prepared using a ratio of (a) to (b), equivalent to 1:0.05 to 1:0.7, based on the dry weight of each component.

A further object of the instant invention is an aqueous preparation comprising the instant cross-linked polymer, the use of the instant cross-linked polymer, optionally in the form of said aqueous preparation, as an additive in the processing of cellulosic fibrous material, preferably as an additive in the production of paper or non-wovens.

The instant cross-linked polymer may also be used to improve dry strength and wet strength of paper or non-wovens.

A further object of the instant invention is a process for making paper with improved dry strength, comprising adding the instant cross-linked polymer.

The aqueous preparation of the instant cross-linked polymer may be applied to paper at a point where the paper is in the form of a cellulosic fibre slurry, a wet web of cellulosic fibres or a partially dried sheet.

The aqueous preparation of the instant cross-linked polymer, with a dominantly cationic backbone, may be added to the cellulosic fibre slurry at an addition level of 0.05 to 1.0% of dry polymer on the weight of dry fibre, more preferably 0.05 to 0.4%.

The aqueous preparation of the instant cross-linked polymer, with a dominantly cationic, anionic or nonionic backbone, may be sprayed through fine nozzles on the surface of a wet cellulosic web, at an addition level of 0.05 to 1.0% of dry polymer on the weight of dry fibre, more preferably 0.05 to 0.2%.

The aqueous preparation of the instant cross-linked polymer, with a dominantly cationic, anionic or nonionic backbone, can be applied to a partially dried paper sheet at a size press or film press, at an addition level of 0.05 to 1.0% of dry polymer on the weight of dry fibre, more preferably 0.05 to 0.15%.

The aqueous preparation of the instant cross-linked polymer, with a dominantly cationic backbone, is added to the cellulosic fibre slurry and then a second aqueous preparation of the instant cross-linked polymer, with a dominantly anionic charge, is sprayed through fine nozzles on the surface of the treated wet cellulosic web or is applied to the partially dried treated paper sheet at a size press or film press.

The second cross-linked polymer can be formed from a dominantly anionic backbone, a co-polymer of acrylamide and acrylic or methacrylic acid, anionic guar, carboxymethyl cellulose or anionic phenolic resin.

The cationic cross-linked polymer is applied at an addition level of 0.05 to 0.8% of dry polymer on the weight of dry fibre, more preferably 0.05 to 0.20%, and the anionic cross-linked polymer is applied at an addition level of 0.05 to 0.7% of dry polymer on the weight of dry fibre, more preferably 0.05 to 0.15%.

The following examples shall demonstrate the instant invention in more detail.

### EXAMPLES

### Example 1

### Refers to Prior Art

This example describes the manufacture of a polymer, using a two-dimensional polyamideamine backbone, which is then cross-linked with a two-dimensional dichloro-derivative.

Diethylenetriamine (108 g) and water (25 g) were mixed in a reaction flask equipped with a stirrer, distillation column, a temperature probe and an inlet for an inert gas. Adipic acid (146 g) was then added with stirring. The mixture was heated gradually to 170° C., under a constant stream of nitrogen gas. The original water and additional water from the reaction began to distil at around 120° C., and were collected in a receiver flask. Stirring at 170° C. was continued for a further 7 hours, until the distillation had ceased. The source of heating was removed and the distillation apparatus set for reflux. Water (330 g) was added, very slowly at first, to dilute the backbone polymer and form a stable low viscosity 40% solution (542 g yield), at a temperature of 70-75° C. The backbone polymer (542 g) was then further diluted with water (450 g) and cross-linked in a stepwise manner, over a period of 12 hours, through the gradual addition of epichlorohydrin (45 g in total). The cross-linking reaction was monitored by measuring the polymer solution viscosity and when a value of 150 mPas (Brookfield RVT, spindle 3, speed 100 rpm) was reached, no further additions of epichlorohydrin were made. The polymer solution was cooled to 40° C. and the pH adjusted to pH 6.0-6.5 with 50% sulphuric acid (75 g). The yield (1496 g) was achieved by adding more water, resulting in a polymer solution with a solid content of 20%.

Using the procedure in comparative example 1, several variations of cross-linked polymers were produced, using different raw materials and molecular ratios. The example preparations were all finished to the same physical specifications; namely 20% solid content, a pH value of 6.0-6.5 and a viscosity of 200-300 mPas (Brookfield RVT, spindle 3, speed 100 rpm). It is a clear intention of the present invention to provide finished polymers with no free reactive cross-linker, ensuring a long shelf life, with no increase in viscosity, and minimizing the contribution of the dry strength polymers to the wet strength of the paper sheet. Example preparations are summarised in the table below (Examples 1-15)

TABLE 1
EXAMPLES 1-15, PREPARATION

| Ex. | (Poly)-amine | (Poly)-acid | Cross-linker |
|---|---|---|---|
| 1 | Diethylenetriamine | Adipic acid | Epichlorohydrin |
| comp. | (1.05 mole) | (1.0 mole) | (0.143 mole) |
| 2 | Diethylenetriamine | Adipic acid | Ethylene glycol diglycidyl |
| | (1.05 mole) | (1.0 mole) | ether (0.172 mole) |
| 3 | Diethylenetriamine | Adipic acid | Methylene bis-acrylamide |
| | (1.05 mole) | (1.0 mole) | (0.23 mole) |
| 4 | Diethylenetriamine | Adipic acid | Glycerol diglycidyl ether |
| | (1.05 mole) | (1.0 mole) | (0.19 mole) |
| 5 | Diethylenetriamine | Adipic acid | Glycerol triglycidyl ether |
| | (1.05 mole) | (1.0 mole) | (0.15 mole) |
| 6 | Diethylenetriamine | Adipic acid | Sorbitol triglycidyl ether |
| | (1.05 mole) | (1.0 mole) | (0.12 mole) |
| 7 | Diethylenetriamine | Adipic acid | Cross-linker of formula |
| | (1.05 mole) | (1.0 mole) | (III) (0.21 mole) |
| 8 | Diethylenetriamine | Adipic acid (0.5 mole) + | Glycerol diglycidyl ether |
| | (1.05 mole) | 1,2,4-benzenetricarboxylic | (0.12 mole) |
| | | acid (0.32 mole) | |
| 9 | Diethylenetriamine | Adipic acid (0.5 mole) + | Glycerol triglycidyl ether |
| | (1.05 mole) | 1,2,4-benzenetricarboxylic | (0.09 mole) |
| | | acid (0.32 mole) | |
| 10 | Diethylenetriamine | Adipic acid (0.5 mole) + | sorbitol triglycidyl ether |
| | (1.05 mole) | 1,2,4-benzenetricarboxylic | (0.08 mole) |
| | | acid (0.32 mole) | |
| 11 | Diethylenetriamine | Adipic acid (0.5 mole) + | Cross-linker of formula |
| | (1.05 mole) | 1,2,4-benzenetricarboxylic | (III) (0.11 mole) |
| | | acid (0.32 mole) | |
| 12 | Diethylenetriamine | Adipic acid | Glycerol diglycidyl ether |
| | (1.0 mole) + triamine | (1.0 mole) | (0.13 mole) |
| | of formula (I) (0.32 | | |
| | mole) | | |
| 13 | Diethylenetriamine | Adipic acid | Glycerol triglycidyl ether |
| | (1.0 mole) + triamine | (1.0 mole) | (0.10 mole) |
| | of formula (I) (0.32 | | |
| | mole) | | |
| 14 | Diethylenetriamine | Adipic acid | sorbitol triglycidyl ether |
| | (1.0 mole) + triamine | (1.0 mole) | (0.095 mole) |
| | of formula (I) (0.32 | | |
| | mole) | | |
| 15 | Diethylenetriamine | Adipic acid | Cross-linker of formula |
| | (1.0 mole) + triamine | (1.0 mole) | (III) (0.13 mole) |
| | of formula (I) (0.32 | | |
| | mole) | | |

The samples produced from examples 1-15 were assessed in a papermaking laboratory, to evaluate their dry strength performance on a paper sheet.

A 2% pulp slurry was prepared in a 25 litre laboratory pulper by adding 400 g of bleached hardwood fibre, 19.6 litres of tap water and agitating for 20 minutes.

1 litre of fibre slurry) was placed in a suitable container, with stirrer, and the required amount of dry strength polymer was added. Stirring at 500 rpm was continued for 60 seconds. Addition levels of 0.2 and 0.4% (dry polymer based on the weight of dry fibre) of the example preparations 1-16 were used in the tests. 200 ml samples of the treated stock were then taken and formed into a handsheet using the British Standard Sheet Forming Apparatus. For each test, 4 handsheets were made, to obtain a meaningful average. “Control” sheets contained no dry strength polymer. After couching from the forming wire, using two blotters, the sheets were then pressed onto stainless steel plates at 4.0 bar for 4 minutes, placed into drying rings and dried at 100° C. in an oven for 30 minutes. After conditioning at 50° RH and 23° C. for a minimum period of 12 hours, the sheets were ready for strength assessment, carried out in the following manner:

### Burst Strength

The sheets were subjected to dry burst strength testing (TAPPI Standard T403 OM-91, Bursting Strength of Paper). Results were recorded as a burst index (=burst value in kPa, divided by the sheet weight in grams per square meter)

### Tensile Strength

The sheets were subjected to wet and dry tensile strength testing, evaluated using a Lloyd WRK5 Tensile Tester. Three 15 mm wide strips were cut from each sample sheet. For the dry strength measurement, the strip was clamped in the jaws of the Lloyd WRK5 and the tensile test started. For the wet strength measurement, the strip was first soaked in deionised water for 60 seconds. Excess water was then removed and the wet strip subjected to the tensile test method, described above. Results were recorded as a tensile index(=tensile value in Newtons, divided by the sheet weight in grams per square meter).

TABLE 2
EXAMPLES 1-15 APPLICATION TEST RESULTS

| | Addition level 0.2% (dry) | | | Addition level 0.4% (dry) | | |
|---|---|---|---|---|---|---|
| | Burst | Tensile | Wet tensile | Burst | Tensile | Wet Tensile |
| Example | index | index | index | index | index | index |
| Control | 1.32 | 0.39 | 0 | 1.32 | 0.39 | 0 |
| 1 comp. | 1.47 | 0.42 | 0.05 | 1.58 | 0.51 | 0.06 |
| 2 | 1.49 | 0.43 | 0.02 | 1.60 | 0.50 | 0.03 |
| 3 | 1.48 | 0.43 | 0.02 | 1.58 | 0.51 | 0.02 |
| 4 | 1.50 | 0.44 | 0.02 | 1.61 | 0.52 | 0.04 |
| 5 | 1.54 | 0.48 | 0.03 | 1.70 | 0.54 | 0.05 |
| 6 | 1.55 | 0.48 | 0.04 | 1.73 | 0.55 | 0.06 |
| 7 | 1.51 | 0.45 | 0.03 | 1.68 | 0.50 | 0.04 |
| 8 | 1.59 | 0.49 | 0.03 | 1.80 | 0.58 | 0.05 |
| 9 | 1.69 | 0.59 | 0.04 | 2.00 | 0.68 | 0.07 |
| 10 | 1.71 | 0.60 | 0.04 | 2.09 | 0.71 | 0.06 |
| 11 | 1.68 | 0.57 | 0.04 | 1.94 | 0.66 | 0.06 |
| 12 | 1.58 | 0.50 | 0.03 | 1.78 | 0.57 | 0.05 |
| 13 | 1.66 | 0.55 | 0.04 | 1.92 | 0.65 | 0.05 |
| 14 | 1.66 | 0.56 | 0.03 | 1.93 | 0.65 | 0.06 |
| 15 | 1.62 | 0.53 | 0.04 | 1.89 | 0.62 | 0.04 |

### Interpretation of Results

The index values recorded during the assessment of the example preparations are directly proportional to the strength of the paper sheet. The highest index values are attributed to 3-dimensional backbone polymers, which have been further polymerized using a tri-functional cross-linking chemical. Preparations representing the prior art, such as comparative example 1, are clearly inferior to the present invention.

The wet tensile values, as expected, were too low to adversely affect the recyclability of the finished paper.

1. A cross-linked polymer formed by reaction between at Least one polyamide polymer backbone (a), with or without side chains, which is the reaction product of at least one di- or tri-primary amine or mixtures thereof, and at least one di- or tri- or tetra-carboxylic acid or mixtures thereof, and at least one trifunctional crosslinking agent (b), based on trichloro-, triepoxy- or trivinyl- functional groups, or a crosslinking agent of formula (lll) 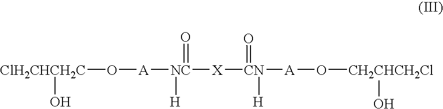
where A is -(CH₂)₂₋₆- and X is benzene or -(CH₂)₂₋₆-.

2. A cross-linked polymer according to claim 1, wherein the at least one tri-primary amine is tris(2-aminoethyl)amine or 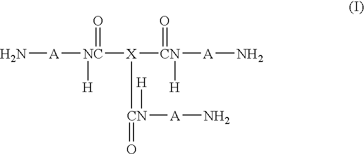
or 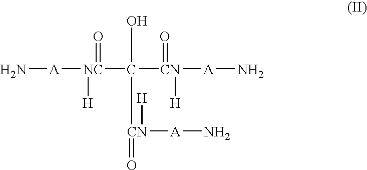
where A is -(CH₂)₂₋₆- and X is benzene.

3. A cross-linked polymer according to claim 1, wherein the at Least one di-carboxylic acid is adipic or terephthalic acid.

4. A cross-linked polymer according to claim 1, wherein the at least one tri-carboxylic acid is 1,2,4-benzenetricarboxylic or nitrilotriacetic acid.

5. A cross-linked polymer according to claim 1, wherein the at least one trifunctional crosslinking agent (b) is N,N-diglycidyl-4- glycidyloxyaniline or glycerol propoxylate triglycidyl ether.

6. A cross-linked polymer according to claim 1, wherein the at least one polyamide polymer, with internal secondary amine groups, is further reacted with benzyl chloride, propylene oxide, ethylene oxide, glycidol or a C₄-C₁₈-alkenyl succinic anhydride, forming a dominantly cationic polymer backbone with side chanis

7. A cross-linked polymer according to claim 1, wherein the at least one polyamide polymer, with internal secondary amine groups, is further reacted with acrylic acid, chloroacetic acid, glyoxylic acid or 3- chloro-2-hydroxy-1-propanesulphonic acid sodium salt, in the presence of sodium or potassium hydroxide, forming a dominantly anionic polymer backbone at a pH value >6.0.

8. A cross-linked polymer according to claim 1, wherein the at least one polyamide polymer, without internal secondary amine groups, is further reacted with glyoxylic acid in the presence of sodium or potassium hydroxide, forming a nonionic polymer backbone with anionic side chains.

9. An aqueous preparation comprising at least one cross-linked polymer according to claim 1.

10. A process for making a paper with improved dry strength, comprising the step of adding at least one cross-linked polymer according to claim 1,during the paper production process.

11. A process for making paper with improved dry strenght, comprising the step of adding at least one aqueous preparation according to claim 9, during the paper production process.
